(19) United States
(12) Patent Application Publication
(10) Pub. No.: US 2017/0017126 A1
(43) Pub. Date: Jan. 19, 2017

(54) Liquid Crystal Panel and Pixel Structure Thereof

(71) Applicant: Shenzhen China Star Optoelectronics Technology Co., Shenzhen, Guangdong (CN)

(72) Inventor: Bing HAN, Shenzhen, Guangdong (CN)

(73) Assignee: Shenzhen China Star Optoelectronics Technology Co. Ltd., Shenzhen, Guangdong (CN)

(21) Appl. No.: 14/775,712

(22) PCT Filed: Jul. 23, 2015
(86) PCT No.: PCT/CN2015/084882

§ 371 Date: Sep. 13, 2015

(30) Foreign Application Priority Data
Jul. 13, 2015 (CN) 201510410368.X

(51) Int. Cl. G02F 1/1343; G02F 1/1362; G02F 1/1335

(52) U.S. Cl. CPC G02F 1/134309; G02F 1/133514; G02F 1/13439; G02F 1/136286; G02F 2201/40

(57) ABSTRACT

The disclosure is related to a pixel structure. The pixel structure comprises a plurality of signal lines intersecting vertically and horizontally, and a plurality of pixel units in the plurality of regions surrounded by the signal lines, the pixel units comprise obscures formed during optical alignment, at least portion of the signal lines around each of the pixel unit is configured to be bended such that the signal lines configured to be bended overlap with at least portion of the obscures at the periphery of the pixel units. The disclosure is further related to a liquid crystal panel having the above pixel structure. By way of the above configuration, the disclosure may increase the aperture ratio of the pixel.

### BACKGROUND

Technical Field

The disclosure is related to liquid crystal display technology field, and more particular to a liquid crystal panel and a pixel structure thereof.

Related Art

In TFT-LCD production, there are two alignment methods: friction alignment and optical alignment. The friction alignment generates electrostatic and particulates pollution. The optical alignment is a non-contact type of alignment technology, using the linear polarized light to irradiate on the light sensitive polymer alignment film to form an inclination angle.

The optical alignment may solve the problem of the occurrence of the electrostatic and particulates pollution. However, the optical alignment may form “ [symbol] ”-shaped obscure or “ [symbol] ”-shaped obscure in the internal of the pixel unit. The obscures seriously affect the aperture rate of the pixel.

Therefore, a liquid crystal panel and a pixel structure thereof are desirous to solve the above technical problems.

### SUMMARY

The main problem solved by the disclosure is to provide a liquid crystal panel and a pixel structure thereof to increase the aperture rate of the pixel.

In order to solve the above problem, one technical solution adopted by the disclosure is to provide a pixel structure. the pixel structure comprises a plurality of signal lines intersecting vertically and horizontally, and a plurality of pixel units in the plurality of regions surrounded by the signal lines, the pixel units comprises obscures formed during optical alignment, at least portion of the signal lines around each of the pixel unit is configured to be bended such that the signal lines configured to be bended overlap with at least portion of the obscures at the periphery of the pixel units; wherein the plurality of signal lines comprises a plurality of parallel data lines and a plurality of parallel scan lines, the pixel units are rectangular, the long sides of the pixel units and the scan lines extend along a first direction, the short sides of the pixel units and the scan lines extend along a second direction perpendicular to the first direction, and the obscures are in the “ [symbol] ”-shape.

In one embodiment, the obscures comprise a first long side obscure, a second long side obscure, a first short obscure and a second short obscure arranged at the periphery of the pixel unit; the first long side obscure and the second long side obscure are at the two long sides of the pixel unit respectively, and extend toward the opposite direction from the central point of the long sides; the first short side obscure and the second short side obscure are at the two short sides of the pixel unit respectively, and extend toward the opposite direction from the central points of the short sides.

In order to solve the above problem, another technical solution adopted by the disclosure is to provide a pixel structure. The pixel structure comprises a plurality of signal lines intersecting vertically and horizontally, and a plurality of pixel units in the plurality of regions surrounded by the signal lines, the pixel units comprise obscures formed during optical alignment, at least portion of the signal lines around each of the pixel unit is configured to be bended such that the signal lines configured to be bended overlap with at least portion of the obscures at the periphery of the pixel units.

In one embodiment of the pixel structure, the plurality of signal lines comprises a plurality of parallel data lines and a plurality of parallel scan lines, the pixel units are rectangular, the long sides of the pixel units and the scan lines extend along a first direction, the short sides of the pixel units and the scan lines extend along a second direction perpendicular to the first direction.

In one embodiment of the pixel structure, the obscures comprise a first long side obscure, a second long side obscure, a first short obscure and a second short obscure arranged at the periphery of the pixel unit; the first long side obscure and the second long side obscure are at the two long sides of the pixel unit respectively, and extend toward opposite direction from the central point of the long side; the first short side obscure and the second short side obscure are at the two short sides of the pixel unit respectively, and extend toward the opposite direction from the central points of the short sides.

In one embodiment of the pixel structure, the scan lines are configured to be bended; the adjacent two scan lines overlap with the first long side obscure and the second long side obscure of the pixel unit respectively.

In one embodiment of the pixel structure, the data lines are configured to be bended; the adjacent two scan lines overlap with the first short side obscure and the second short side obscure of the pixel unit respectively.

In one embodiment of the pixel structure, the length of the first long side obscure and the second long side obscure is half of the length of the long side of the pixel unit.

In one embodiment of the pixel structure, the length of the first short side obscure and the second short side obscure is half of the length of the short side of the pixel unit.

In one embodiment of the pixel structure, the scan lines and the data lines are configures to be bended; the adjacent two scan lines overlap with the first long side obscure and the second long side obscure respectively; the adjacent two data lines overlap with the first short side obscure and the second short side obscure respectively.

In one embodiment of the pixel structure, the obscures are in the “ [symbol] ”-shape.

In order to solve the above problem, another technical solution adopted by the disclosure is to provide a liquid crystal panel comprising an array substrate and a color filter substrate and a liquid crystal layer sandwiched between the array substrate and the color filter substrate, the array substrate arranged with pixel structures comprising a plurality of signal lines intersecting vertically and horizontally and a plurality of pixel units in the plurality of regions surrounded by the signal lines, the pixel units comprising obscures formed during optical alignment, at least portion of the signal lines around each of the pixel unit configured to be bended such that the signal lines configured to be bended overlap with at least portion of the obscures at the periphery of the pixel units.

In one embodiment of the liquid crystal panel, the plurality of signal lines comprises a plurality of parallel data lines and a plurality of parallel scan lines, the pixel units are rectangular, the long sides of the pixel units and the scan lines extend along a first direction, the short sides of the pixel units and the scan lines extend along a second direction perpendicular to the first direction.

In one embodiment of the liquid crystal panel, the obscures comprise a first long side obscure, a second long side obscure, a first short obscure and a second short obscure arranged at the periphery of the pixel unit; the first long side obscure and the second long side obscure are at the two long sides of the pixel unit respectively, and extend toward opposite direction from the central point of the long side; the first short side obscure and the second short side obscure are at the two short sides of the pixel unit respectively, and extend toward the opposite direction from the central points of the short sides.

In one embodiment of the liquid crystal panel, the scan lines are configured to be bended; the adjacent two scan lines overlap with the first long side obscure and the second long side obscure of the pixel unit respectively.

In one embodiment of the liquid crystal panel, the data lines are configured to be bended; the adjacent two scan lines overlap with the first short side obscure and the second short side obscure of the pixel unit respectively.

In one embodiment of the liquid crystal panel, the length of the first long side obscure and the second long side obscure is half of the length of the long side of the pixel unit.

In one embodiment of the liquid crystal panel, the length of the first short side obscure and the second short side obscure is half of the length of the short side of the pixel unit.

In one embodiment of the liquid crystal panel, the scan lines and the data lines are configures to be bended; the adjacent two scan lines overlap with the first long side obscure and the second long side obscure respectively; the adjacent two data lines overlap with the first short side obscure and the second short side obscure respectively.

In one embodiment of the liquid crystal panel, wherein the obscures are in the “ [symbol] ”-shape.

The beneficial effects of the disclosure, distinguishing from the prior art, is that the disclosure configures at least part of the signal lines around each of the pixel units to be bended such that the signal lines configured to be bended overlap with at least portion of the obscures at the periphery of the pixel units. The occupied areas of the signal lines and the gate lines are reduced and the aperture ratio is increased.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is the schematic diagram of the pixel structure according to the first embodiment of the disclosure;

FIG. 2 is the schematic diagram of one pixel unit and the signal lines around the pixel unit in the pixel structure according to the first embodiment of the disclosure;

FIG. 3 is the schematic diagram of one pixel unit and the signal lines around the pixel unit in the pixel structure according to the second embodiment of the disclosure;

FIG. 4 is the schematic diagram of one pixel unit and the signal lines around the pixel unit in the pixel structure according to the third embodiment of the disclosure; and

FIG. 5 is the schematic diagram of the liquid crystal panel according to the embodiment of the disclosure.

### DETAILED DESCRIPTION

The following description with reference to the accompanying drawings is provided to explain the exemplary embodiments of the disclosure in detail.

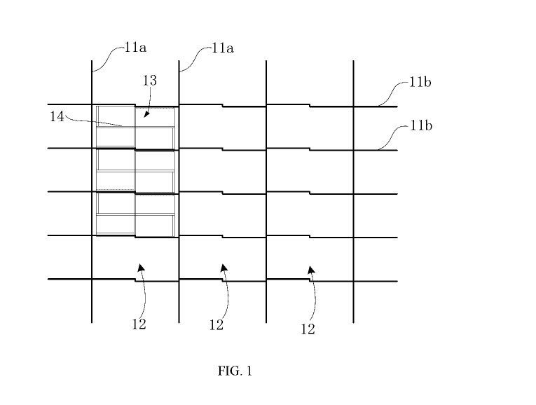

Refer to FIG. 1. FIG. 1 is the schematic diagram of the pixel structure according to the first embodiment of the disclosure. In this embodiment, the pixel structure comprises a plurality of signal lines 11a, 11b intersecting vertically and horizontally, and a plurality of pixel units 13 in the plurality of regions 12 surrounded by the signal lines 11a, 11b. FIG. 1 merely illustrates three pixel units 13 in the three regions 12. It should be appreciated that each region 12 surrounded by the signal lines 11a, 11b is provided with a pixel unit 13. FIG. 1 is merely exemplary.

The pixel unit 13 comprises obscures formed during optical alignment.

At least portion of the signal lines 11a, 11b around each of the pixel unit 13 is configured to be bended such that the signal lines 11b configured to be bended overlap with at least portion of the obscures 14 at the periphery of the pixel units 13.

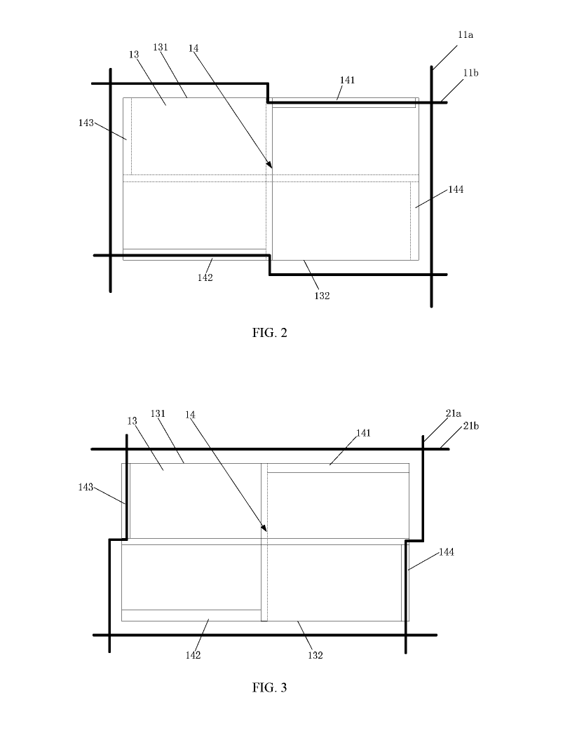

In one embodiment, the plurality of signal lines 11a, 11b comprises a plurality of parallel data lines 11 a and a plurality of parallel scan lines 11b. The pixel units 13 are rectangular. The long sides of the pixel units 13 and the scan lines 11b extend along a first direction. The short sides of the pixel units 13 and the scan lines 11a extend along a second direction perpendicular to the first direction. In one embodiment, the first direction is the horizontal direction in FIG. 1, and the second direction is the vertical direction in FIG. 2. It should be appreciated that for the other direction arrangement, the first direction and the second direction may be other directions.

In conjunction with FIG. 1 and refer to FIG. 2. FIG. 2 is the schematic diagram of one pixel unit and the signal lines around the pixel unit in the pixel structure according to the first embodiment of the disclosure. As shown in FIG. 2, in one embodiment, the obscure 14 comprises a first long side obscure 141, a second long side obscure 142, a first short obscure 143 and a second short obscure 144 arranged at the periphery of the pixel unit 13. The first long side obscure 141 and the second long side obscure 142 are at the two long sides 131, 132 of the pixel unit 13 respectively, and extend toward opposite direction from the central point of the long sides 131, 132. As shown in FIG. 2, the first long side obscure 141 is at the long side 131 of the pixel unit 13 and extends toward right from the central point of the long side 131. The second long side obscure 142 is at the long side 132 of the pixel unit 13 and extends toward left from the central point of the long side 132.

The first short side obscure 143 and the second short side obscure 144 are at the two short sides 133, 134 of the pixel unit 13 respectively, and extend toward the opposite direction from the central points of the short sides 133, 134. As shown in FIG. 2, the first short side obscure 143 is at the short side 133 of the pixel unit 13 and extends upward from the central point of the short side 133. The second short side obscure 144 is at the short side 134 of the pixel unit 13 and extends downward from the central point of the short side 134.

In one embodiment, the obscure is in the “ [symbol] ”-shape, or alternatively it may be “ [symbol] ”-shape when it is in a different direction arrangement. Besides the first long side obscure 141, the second long side obscure 142, the first short obscure 143 and the second short obscure 144 arranged at the periphery of the pixel unit 13, the obscures 14 further comprise “ [symbol] ”-shaped obscures in the center of the pixel unit 13.

In one embodiment, the scan lines 11b are configured to be bended; the adjacent two scan lines 11b overlap with the first long side obscure 141 and the second long side 142 obscure of the pixel unit 13 respectively. The data lines 11a are configured as straight lines.

In one embodiment, the length of the first long side obscure 141 and the second long side obscure 142 is half of the length of the long side of the pixel unit 13.

In one embodiment, the length of the first short side obscure 143 and the second short side obscure 144 is half of the length of the short side of the pixel unit 13.

Refer to FIG. 3. FIG. 3 is the schematic diagram of one pixel unit and the signal lines around the pixel unit in the pixel structure according to the second embodiment of the disclosure. Compared with the first embodiment, in this embodiment, the data lines 21a are configured to be bended; the adjacent two scan lines 21a overlap with the first short side obscure 133 and the second short side obscure 134 of the pixel unit 13 respectively. The scan lines 21b are configured as straight lines.

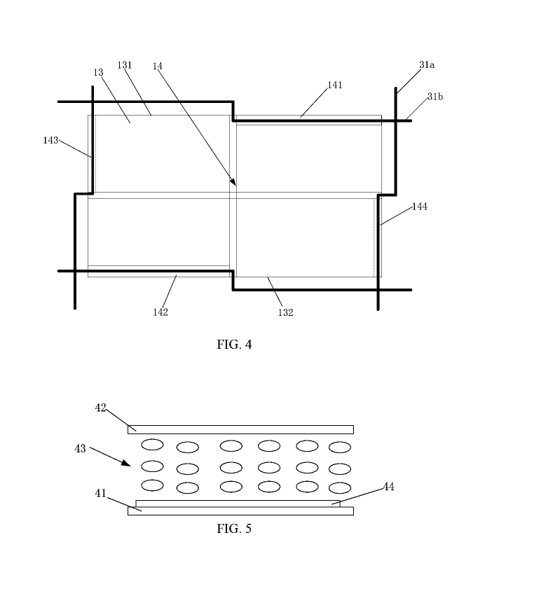

Refer to FIG. 4. FIG. 4 is the schematic diagram of one pixel unit and the signal lines around the pixel unit in the pixel structure according to the third embodiment of the disclosure. Compared with the first embodiment, in this embodiment, the scan lines 31b and the data lines 31a are configures to be bended; the adjacent two scan lines 31b overlap with the first long side obscure 141 and the second long side obscure 142 respectively; the adjacent two data lines 31a overlap with the first short side obscure 143 and the second short side obscure 144 respectively.

The increase of the aperture ratio is illustrated in conjunction with Table I as below.

TABLE I
Table of the increase of the aperture ratio of the embodiments of
the disclosure in relative to the prior art

| | | First | Second | Third |
|---|---|---|---|---|
| | Prior Art | Embodiment | Embodiment | Embodiment |
| Aperture ratio | 72.78% | 80.63% | 74.85% | 82.70% |
| Increase | 100% | 110.78% | 102.84% | 113.63% |
| amount | | | | |

Compared with the prior art, the aperture ratio of the first embodiment increases more than 10%, while the aperture ratio of the second embodiment increases about 3%, and the aperture ratio of the third embodiment increases about 13%.

Refer to FIG. 5. FIG. 5 is the schematic diagram of the liquid crystal panel according to the embodiment of the disclosure. In this embodiment, the liquid crystal panel comprises an array substrate 41 and a color filter substrate 42 and a liquid crystal layer 43 sandwiched between the array substrate 41 and the color filter substrate 42. The array substrate 41 is arranged with pixel structures 44. The pixel structure 44 is the pixel structure of any one of the embodiments as described above.

The disclosure configures at least part of the signal lines around each of the pixel units to be bended such that the signal lines configured to be bended overlap with at least portion of the obscures at the periphery of the pixel units. The occupied areas of the signal lines and the gate lines are reduced and the aperture ratio is increased.

Although the present disclosure is illustrated and described with reference to specific embodiments, those skilled in the art will understand that many variations and modifications are readily attainable without departing from the spirit and scope thereof as defined by the appended claims and their legal equivalents.

What is claimed is:

1. A pixel structure, wherein the pixel structure comprises a plurality of signal lines intersecting vertically and horizontally, and a plurality of pixel units in the plurality of regions surrounded by the signal lines, the pixel units comprises obscures formed during optical alignment, at least portion of the signal lines around each of the pixel unit is configured to be bended such that the signal lines configured to be bended overlap with at least portion of the obscures at the periphery of the pixel units; wherein the plurality of signal lines comprises a plurality of parallel data lines and a plurality of parallel scan lines, the pixel units are rectangular, the long sides of the pixel units and the scan lines extend along a first direction, the short sides of the pixel units and the scan lines extend along a second direction perpendicular to the first direction, and the obscures are in the “ [symbol] ”-shape.

2. The pixel structure according to claim 1, wherein the obscures comprise a first long side obscure, a second long side obscure, a first short obscure and a second short obscure arranged at the periphery of the pixel unit; the first long side obscure and the second long side obscure are at the two long sides of the pixel unit respectively, and extend toward the opposite direction from the central point of the long sides; the first short side obscure and the second short side obscure are at the two short sides of the pixel unit respectively, and extend toward the opposite direction from the central points of the short sides.

3. A pixel structure, wherein the pixel structure comprises a plurality of signal lines intersecting vertically and horizontally, and a plurality of pixel units in the plurality of regions surrounded by the signal lines, the pixel units comprise obscures formed during optical alignment, at least portion of the signal lines around each of the pixel unit is configured to be bended such that the signal lines configured to be bended overlap with at least portion of the obscures at the periphery of the pixel units.

4. The pixel structure according to claim 3, wherein the plurality of signal lines comprises a plurality of parallel data lines and a plurality of parallel scan lines, the pixel units are rectangular, the long sides of the pixel units and the scan lines extend along a first direction, the short sides of the pixel units and the scan lines extend along a second direction perpendicular to the first direction.

5. The pixel structure according to claim 4, wherein the obscures comprise a first long side obscure, a second long side obscure, a first short obscure and a second short obscure arranged at the periphery of the pixel unit; the first long side obscure and the second long side obscure are at the two long sides of the pixel unit respectively, and extend toward opposite direction from the central point of the long side; the first short side obscure and the second short side obscure are at the two short sides of the pixel unit respectively, and extend toward the opposite direction from the central points of the short sides.

6. The pixel structure according to claim 5, wherein the scan lines are configured to be bended; the adjacent two scan lines overlap with the first long side obscure and the second long side obscure of the pixel unit respectively.

7. The pixel structure according to claim 5, wherein the data lines are configured to be bended; the adjacent two data lines overlap with the first short side obscure and the second short side obscure of the pixel unit respectively.

8. The pixel structure according to claim 5, wherein the length of the first long side obscure and the second long side obscure is half of the length of the long side of the pixel unit.

9. The pixel structure according to claim 5, wherein the length of the first short side obscure and the second short side obscure is half of the length of the short side of the pixel unit.

10. The pixel structure according to claim 5, wherein the scan lines and the data lines are configures to be bended; the adjacent two scan lines overlap with the first long side obscure and the second long side obscure respectively; the adjacent two data lines overlap with the first short side obscure and the second short side obscure respectively.

11. The pixel structure according to claim 3, wherein the obscures are in the “ [symbol] ”-shape.

12. A liquid crystal panel comprising an array substrate and a color filter substrate and a liquid crystal layer sandwiched between the array substrate and the color filter substrate, the array substrate arranged with pixel structures comprising a plurality of signal lines intersecting vertically and horizontally and a plurality of pixel units in the plurality of regions surrounded by the signal lines, the pixel units comprising obscures formed during optical alignment, at least portion of the signal lines around each of the pixel unit configured to be bended such that the signal lines configured to be bended overlap with at least portion of the obscures at the periphery of the pixel units.

13. The liquid crystal panel according to claim 12, wherein the plurality of signal lines comprises a plurality of parallel data lines and a plurality of parallel scan lines, the pixel units are rectangular, the long sides of the pixel units and the scan lines extend along a first direction, the short sides of the pixel units and the scan lines extend along a second direction perpendicular to the first direction.

14. The liquid crystal panel according to claim 13, wherein the obscures comprise a first long side obscure, a second long side obscure, a first short obscure and a second short obscure arranged at the periphery of the pixel unit; the first long side obscure and the second long side obscure are at the two long sides of the pixel unit respectively, and extend toward opposite direction from the central point of the long side; the first short side obscure and the second short side obscure are at the two short sides of the pixel unit respectively, and extend toward the opposite direction from the central points of the short sides.

15. The liquid crystal panel according to claim 14, wherein the scan lines are configured to be bended; the adjacent two scan lines overlap with the first long side obscure and the second long side obscure of the pixel unit respectively.

16. The liquid crystal panel according to claim 14, wherein the data lines are configured to be bended; the adjacent two data lines overlap with the first short side obscure and the second short side obscure of the pixel unit respectively.

17. The liquid crystal panel according to claim 14, wherein the length of the first long side obscure and the second long side obscure is half of the length of the long side of the pixel unit.

18. The liquid crystal panel according to claim 14, wherein the length of the first short side obscure and the second short side obscure is half of the length of the short side of the pixel unit.

19. The liquid crystal panel according to claim 14, wherein the scan lines and the data lines are configures to be bended; the adjacent two scan lines overlap with the first long side obscure and the second long side obscure respectively; the adjacent two data lines overlap with the first short side obscure and the second short side obscure respectively.

20. The liquid crystal panel according to claim 14, wherein the obscures are in the “ [symbol] ”-shape.
